(19) United States
(12) Patent Application Publication
(10) Pub. No.: US 2025/0000060 A1
(43) Pub. Date: Jan. 2, 2025

(54) COMMUNICATIVE PET COLLAR DEVICE

(71) Applicants: Line Harris, Taylor, MI (US); Christopher Harris, JR., Taylor, MI (US)

(72) Inventors: Line Harris, Taylor, MI (US); Christopher Harris, JR., Taylor, MI (US)

(21) Appl. No.: 18/532,581

(22) Filed: Dec. 7, 2023

Related U.S. Application Data
(60) Provisional application No. 63/510,909, filed on Jun. 29, 2023.

(51) Int. Cl. A01K 27/00; H04R 1/02

(52) U.S. Cl. CPC A01K 27/001; A01K 27/006; A01K 27/009; H04R 1/025; H04R 2201/029; H04R 2420/07

(57) ABSTRACT

A communicative pet collar paired with a user device for enabling pet owners to communicate with their pets via transmission of commands or instructions on a software application installed in the user device. The collar and the user device are paired using a wireless channel such as Bluetooth and voice signals are captured by the application and are transmitted to the pet collar. A Bluetooth speaker is included in the collar which plays out the commands or messages to the pet wearing the collar. The collar includes a strap to secure around the neck of the pet and can be secured using a buckle. The speaker also includes a housing which stores a vibration module, a rechargeable battery, an LED indicator, and a wireless transceiver.

### CROSS-REFERENCE TO RELATED APPLICATION

The present application claims priority to, and the benefit of, U.S. Provisional Application No. 63/510,909, which was filed on Jun. 29, 2023 and is incorporated herein by reference in its entirety.

### FIELD OF THE INVENTION

The present invention relates generally to the field of pet collars. More specifically, the present invention relates to a novel pet collar device for improving interaction between pet owners and their pets. The collar has a Bluetooth-enabled speaker which integrates with a companion mobile application, enabling users to communicate and provide instructions to their pets. The collar is functional and includes a buckle for securing around a neck of a pet. A pet owner can record messages on the application and the messages are transmitted wirelessly to the collar for playout. Accordingly, the present disclosure makes specific reference thereto. Nonetheless, it is to be appreciated that aspects of the present invention are also equally applicable to other like applications, devices, and methods of manufacture.

### BACKGROUND

By way of background, pet owners employ collars for their pets. The conventional collars serve the dual purpose of identification of pets and facilitating the attachment of leashes for pet control. However, to control and interact with pets, pet owners are required to be in close vicinity to interact with their pets. It generally leads to potential exhaustion and restricts the owner's ability to engage in other activities like sitting or strolling. Also, while at home, limited interaction may lead to boredom in pets which may prompt destructive behaviors such as damaging furniture and belongings within the household.

Traditional collars possess a singular function and do not cater to the evolving needs of pet owners seeking enhanced ways to interact with and control their pets. Pet owners may shout to communicate with pets, which might be inconvenient and ineffective, especially when the pet is only a short distance away. People desire a novel pet collar that not only serves its functional purpose but also offers a means of communication from a limited distance.

Therefore, there exists a long felt need in the art for an improved pet collar that provides an effective communication between pets and owners. There is also a long felt need in the art for a pet collar that facilitates remote interaction between pet owners and pets, enabling convenience and mobility. Additionally, there is a long felt need in the art of a communicative pet collar that improves engagement and interaction with pets. Moreover, there is a long felt need in the art for a pet collar that allows pet owners to communicate messages and train pets from limited distances. Further, there is a long felt need in the art for a novel pet collar that can provide voice messages to the pet using a speaker. Finally, there is a long felt need in the art for an improved pet collar that obviates shouting for providing instructions to pets and offers a way to improve communication between pet owners and their pets.

The subject matter disclosed and claimed herein, in one embodiment thereof, comprises a communicative pet collar to be worn by a pet for enabling a user to wirelessly transmit messages to the collar. The pet collar features a nylon strap, the strap is configured to encircle the neck of a pet comfortably and to accommodate various neck sizes and shapes. A plurality of holes is disposed along the length of the strap and the holes are configured to receive a prong of a buckle for securing the collar around the neck of the pet. A Bluetooth-enabled speaker is slidably attached to the strap and is adapted for communication with a companion mobile application. A vibration module is positioned on the rear surface of the housing, the vibration module is operable to generate vibrations synchronized with audio playback from the speaker. The pet collar is coupled with a software application for enabling the user to record and transmit messages which are played out by the speaker.

In this manner, the communicative pet collar of the present invention accomplishes all of the forgoing objectives and provides users with an innovative collar that enables communication, enabling owners to provide instructions, comfort, and companionship to their pets remotely. The collar mitigates challenges related to physical presence of the owner and prevents the pets from boredom.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a communicative pet collar. The pet collar further comprising an elongated and flexible strap constructed from a soft and sturdy material. The strap is configured to encircle the neck of a pet comfortably and to accommodate various neck sizes and shapes. A plurality of holes is disposed along the length of the strap and the holes are configured to receive a prong of a buckle for securing the collar around the neck of the pet. A Bluetooth-enabled speaker is slidably attached to the strap and is adapted for communication with a companion mobile application. A vibration module is positioned on the rear surface of the housing, the vibration module is operable to generate vibrations synchronized with audio playback from the speaker.

In yet another embodiment, a pet collar designed to receive voice commands from a remote user is disclosed. The pet collar includes a detachably attached speaker, the speaker includes a housing, a Bluetooth module configured to establish a wireless communication channel with a companion software application, a signal processor configured to receive digital signals via the wireless communication channel from the application and perform real-time conversion of the digital signals into analog audio signals for playback by the Bluetooth speaker. The speaker also includes a rechargeable and replaceable battery, a vibration module for generating vibrations on the pet's skin to indicate messages and alerts and a wireless transceiver designed to establish a wireless communication channel.

In another aspect of the present invention, a pet collar device operable to communicate with a handheld user device for enabling a user to communicate with a pet wearing the pet collar is disclosed. The pet collar includes a wireless transceiver configured to establish the wireless communication channel to connect with the user device, a mobile application installed on the handheld user device, the mobile application is further configured to offer a variety of configurable options for controlling and managing the functionalities of the pet collar device, and transmitting the wireless instructions, commands, and/or messages to the pet collar device via the wireless communication channel, facilitating remote control and communication between the user and the pet.

The pet collar device of the present invention is an improved pet collar for communicating with a dog, a cat, or other pet. The device allows pet owners to communicate with their pet and give them commands from a short distance.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a communicative pet collar of the present invention in accordance with the disclosed architecture;

FIG. 2 illustrates a block diagram view showing different internal electronic components of the unique pet collar of the present invention in accordance with the disclosed structure;

FIG. 3 illustrates a schematic view showing the communication between the pet collar device and the companion mobile application in accordance with the disclosed architecture;

FIG. 4 illustrates an exemplary user interface displayed by the mobile application for controlling operations of the pet collar device of the present invention in accordance with the disclosed architecture;

FIG. 5 illustrates a flow chart depicting a process of communication between the collar device and the mobile application in accordance one embodiment of the present invention;

FIG. 6 illustrates a flow chart depicting a process of providing safety notifications on both the collar and the application based on distance between the collar and the user device in accordance with the disclosed architecture;

FIG. 7 illustrates a perspective view of a pet wearing the communicative pet collar of the present invention for playing out an audio message in accordance with the disclosed structure; and

FIG. 8 illustrates an exemplary locking system of the speaker device on the strap of the collar device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved pet collar that provides an effective communication between pets and owners. There is also a long felt need in the art for a pet collar that facilitates remote interaction between pet owners and pets, enabling convenience and mobility. Additionally, there is a long felt need in the art of a communicative pet collar that improves engagement and interaction with pets. Moreover, there is a long felt need in the art for a pet collar that allows pet owners to communicate messages and train pets from limited distances. Further, there is a long felt need in the art for a novel pet collar that can provide voice messages to the pet using a speaker. Finally, there is a long felt need in the art for an improved pet collar that obviates shouting for providing instructions to pets and offers a way to improve communication between pet owners and their pets.

The present invention, in one exemplary embodiment, is a pet collar device operable to communicate with a handheld user device for enabling a user to communicate with a pet wearing the pet collar. The pet collar includes a wireless transceiver configured to establish the wireless communication channel to connect with the user device, a mobile application installed on the handheld user device, the mobile application is further configured to offer a variety of configurable options for controlling and managing the functionalities of the pet collar device, and transmitting the wireless instructions, commands, and/or messages to the pet collar device via the wireless communication channel, facilitating remote control and communication between the user and the pet.

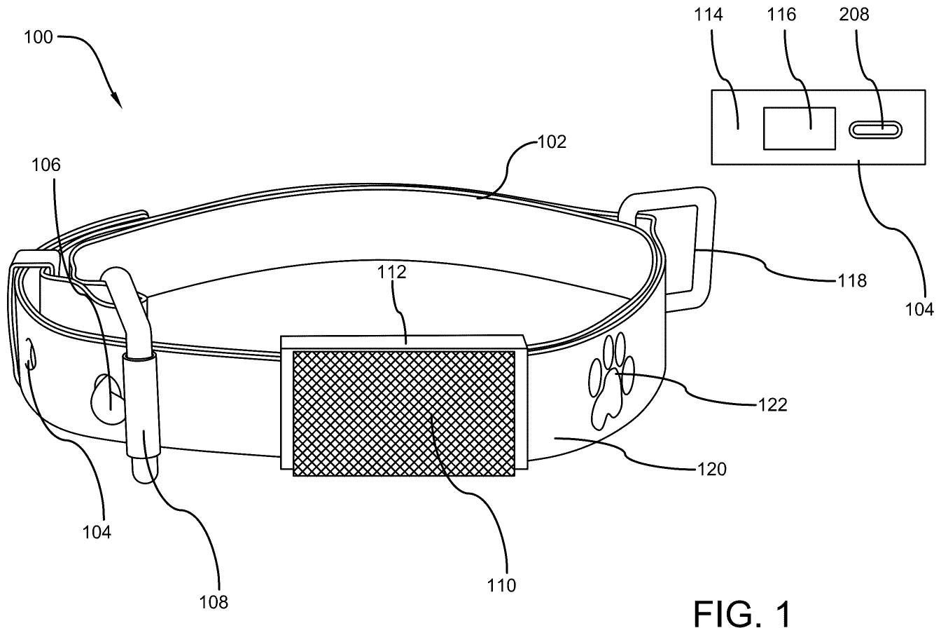

Referring initially to the drawings, FIG. 1 illustrates a perspective view of the communicative pet collar of the present invention in accordance with the disclosed architecture. The communicative pet collar 100 is a purpose-built functional pet collar designed to pair with a companion software application for enabling a user such as a pet owner to communicate and provide instructions to a pet wearing the pet collar 100. More specifically, the pet collar 100 includes an elongated and flexible strap 102 which is designed to encircle the neck of the pet comfortably while accommodating various neck sizes and shapes. The strap 102 is made of a soft and sturdy material such as nylon.

The strap 102 has a plurality of holes 104 disposed therein along the length of the strap 102. The holes 104 are used for accommodating a prong 106 of a buckle 108 for securing the collar 100 around the neck of the pet. The size of each hole is designed to allow the prong to easily insert therethrough to adjust and secure the collar 100.

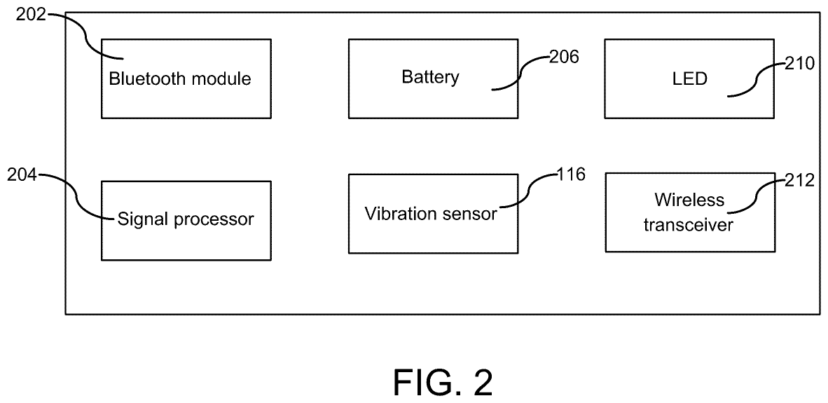

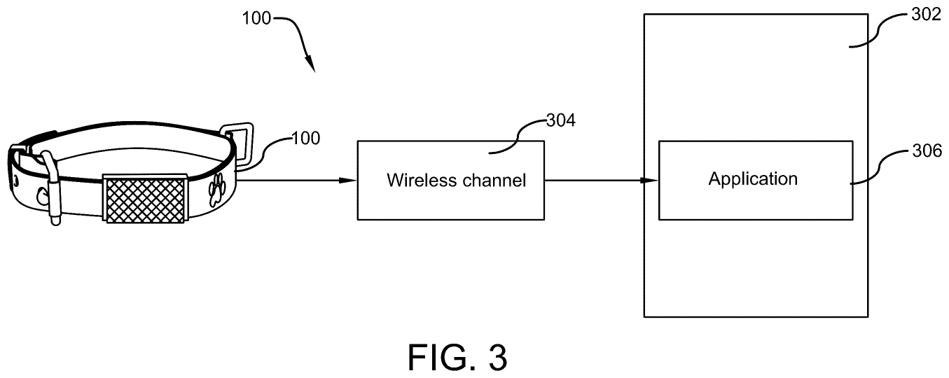

For providing messages and instructions to the pet wearing the collar 100, a Bluetooth-enabled speaker 110 is slidably attached to the strap 102. The speaker 110 adheres to a portion of the strap 102 and provides communication with a companion mobile application as illustrated in FIG. 3. The Bluetooth speaker 110 can play out audio in the audible range of pets such as dogs and cats and more specifically, plays out audio in the range from about 50 Hz to about 5000 Hz. The Bluetooth speaker 110 has a housing 112 which is generally square or rectangular but can be of any geometrical shape and can be removed from the strap 102 for repairing and replacing with a new speaker. The speaker 110 can be a micro speaker, piezoelectric speaker, or any other conventional speaker. The housing 112 is waterproof and houses a plurality of electronic components as illustrated in FIG. 2.

The rear surface 114 of the housing 112 includes a vibration module 116 for generating a vibration when an audio is played out by the speaker 110. The vibration module 116 and the speaker 110 can function independently and the vibration module 116 provides a gentle vibration for alerting the pet for a message.

The collar 100 includes an adjustable loop 118 to customize the length of the strap 102 enabling the collar 100 to fit around the neck of different pets. The loop 118 and the buckle 108 provides a snug fit around the neck of a pet without any discomfort or irritation. The loop 118 can also be used for detachably attaching a leash for easily controlling the pet by a user. The outer surface 120 of the strap 102 has a logo, indicia, or trademark 122 for marketing or branding purposes and can be printed or embossed as per manufacturing and consumer requirements.

It will be appreciated by those skilled in the art that the improved pet collar 100 of the present invention can have different types of buckles such as buckles with male and female members or adhesive strips for fastening around the neck of a pet.

FIG. 2 illustrates a block diagram view showing different internal electronic components of the unique pet collar of the present invention in accordance with the disclosed structure. The Bluetooth speaker 110 includes a Bluetooth module 202 for establishing a Bluetooth channel as illustrated in FIG. 3 for communicating with a companion software application. The Bluetooth module 202 can be configured to use other wireless communication technologies such as Wi-Fi, Infrared, and can be provided with Bluetooth Low Energy, Bluetooth 5.1 and more.

A signal processor 204 is included in the speaker 110 for receiving digital signals via the wireless channel and converting same into analog audio signals for being played out by the speaker 110. The signal processor 204 converts the digital to audio signal in real-time and may include noise cancellation functionality for providing clear sound to the pet.

A battery 206 in the speaker 110 provides electric power required for functionality of the electronic components. The battery 206 is rechargeable and replaceable and can be charged using a charging port 208 (shown in FIG. 1). The charging port 208 can be a USB, micro-USB, mini-USB, type C, or any other charging port. In some embodiments, the speaker 110 can be recharged wirelessly using wireless charging technology. As described earlier, the vibration module 116 may work in conjunction with the speaker 110 for vibrating skin of the pet for indicating a message and alerting the pet.

An LED 210 is included in the housing 112 which can illuminate or flash during playing of audio messages. Also, the LED 210 can be illuminated remotely by a pet owner using the companion mobile application. The LED 210 helps in locating the pet wearing the collar 100 and, in some embodiments, the LED 210 may also illuminate in a specific color such as Red to indicate malfunction in the speaker device 110. A wireless transceiver 212 included in the housing 112 establishes a wireless channel for enabling the speaker device 110 to pair with one or more user handheld devices.

All the electronic components are interconnected and can be designed on a single PCB board or can be in the form of integrated chips or ASICs. Furthermore, the housing 112 provides a sealed enclosure for protection of the components from physical damage and weather elements.

In some embodiments of the present invention, the collar 100 may have a vital sign detector for detecting vital signs such as heart rate and temperature of the pet and wirelessly transmit same to the companion software application.

FIG. 3 illustrates a schematic view showing the communication between the pet collar device and the companion mobile application in accordance with the disclosed architecture. The pet collar device 100 may be paired with a handheld user device 302 using a wireless communication channel 304, preferably a Bluetooth channel. The wireless transceiver 212 establishes the channel 304 and allows the mobile application 306 to control and operate the collar device 100.

The application 306 is configured to provide a plurality of options to configure and control the operations of the collar device 100. It will be apparent to a person skilled in the art that a pet owner can communicate with the pet wearing the collar device 100 using mobile application 306 by providing wireless instructions, commands, and/or messages. This not only reduces the use of a leash to control the pet but also allows both the pet and the pet owner to be free while remaining in virtual proximity.

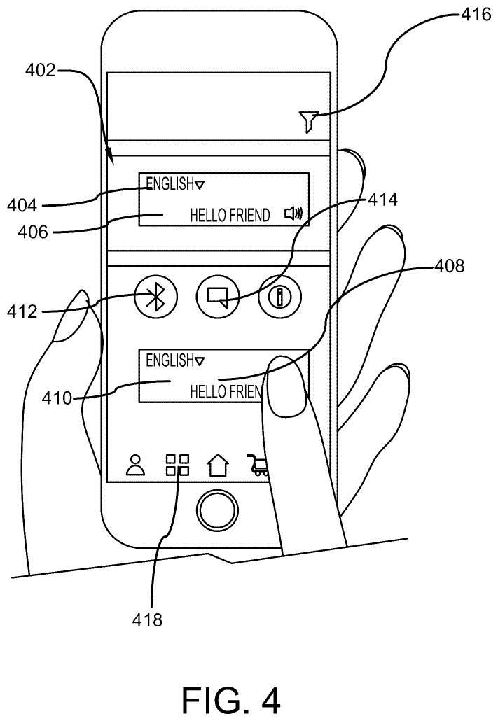

FIG. 4 illustrates an exemplary user interface displayed by the mobile application for controlling operations of the pet collar device of the present invention in accordance with the disclosed architecture. The user interface 402 displayed by the application 306 allows a user to input a voice message for transmission to the speaker device 110. The application 306 supports multiple languages and the desired language can be selected using language tab 404. The voice command box 406 displays the message as well for review which can also be played out by the user device 302.

An option to input textual message 408 is also provided by the application 306 using the textual box 410. Both the voice message and textual message can be used by the user for sending a message to the collar device 100 for communication with the pet. The application 306 can be paired to the collar device 100 using the Bluetooth icon 412. A translating icon 414 provides translation of any language into English or any other default language.

The mobile application 306 allows the user to change the volume of the speaker 110 using the volume button 416 and can remotely turn on/off the collar device 100 using the power button 418. The collar device 100 can be paired with one or more applications and receives communication using the wireless channel 304.

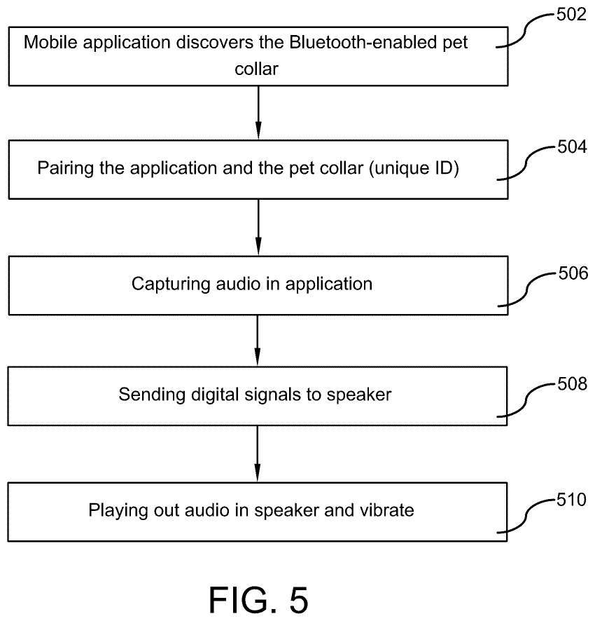

FIG. 5 illustrates a flow chart depicting a process of communication between the collar device 100 and the mobile application 306 in accordance with one embodiment of the present invention. Initially, in step 502, the mobile application 306 discovers the Bluetooth-enabled pet collar 100 by receiving the Bluetooth PIN of the collar device. The collar device 100 transmits a Bluetooth beacon signal which is captured by application 306 to discover the collar device 100. Then, in step 504, the application 306 and the pet collar 100 are paired which can include configuring the unique ID of the collar 100 in the application 306. In the next step 506, the application 306 captures the audio from a user as described in FIG. 4 for transmission to the speaker 110.

In step 508, the application 306 transforms the captured message into digital signals and transmits via Bluetooth channel to the collar device 100. Finally, in step 510, the speaker device 110 receives the digital signals and converts same into analog audio signals for playing out for the pet.

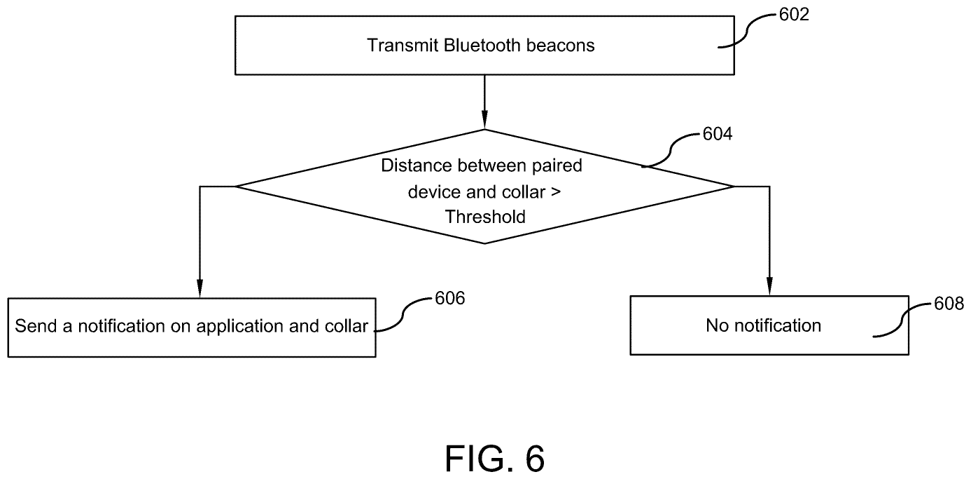

FIG. 6 illustrates a flow chart depicting a process of providing safety notifications on both the collar and the application based on distance between the collar and the user device in accordance with the disclosed architecture. In the present embodiment, the collar device 100 is configured to transmit periodic Bluetooth beacons to the paired smartphone application which allows the application to determine location of the collar device 100 (Step 602). During configuration of the collar device 100, the application 306 can be used to configure a maximum distance between the application 306 and the collar device 100. The system compares the distance between the application 306 (i.e., paired device) and the collar device 100 with a threshold value (maximum distance) (Step 604). In situations where the distance is more than the threshold value, a notification is sent to both the applicant and the collar device indicating a longer distance (Step 606). This helps a pet owner in monitoring location of a pet wearing the pet collar 100. If the distance is less than the threshold value, then a notification is not sent to the application and the collar 100 (Step 608).

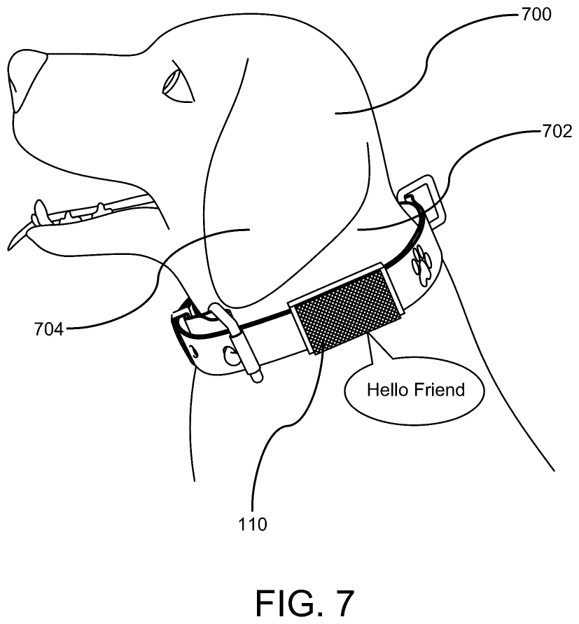

FIG. 7 illustrates a perspective view of a pet wearing the communicative pet collar of the present invention for playing out an audio message in accordance with the disclosed structure. As illustrated, the collar device 100 is worn around the neck 702 of a pet 700 and is secured using the buckle 108. The speaker device 110 is positioned to be near one of the ears 704 of the pet 700 and plays out the message received remotely from the application 306.

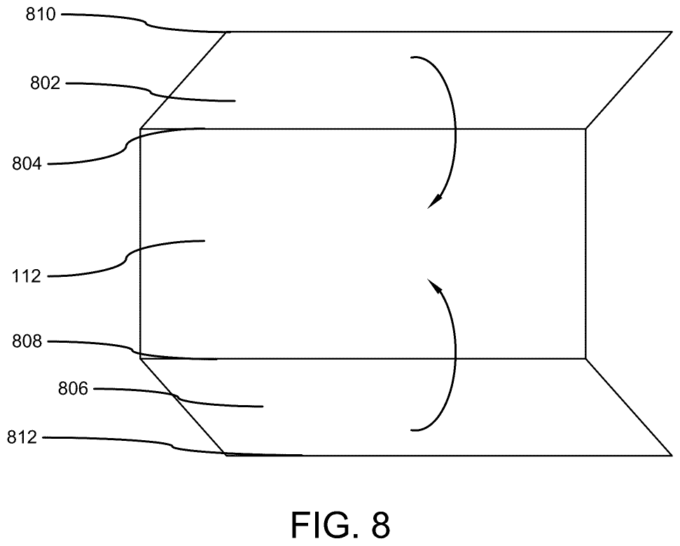

FIG. 8 illustrates an exemplary locking system of the speaker device 110 on the strap 102 of the collar device 100 of the present invention in accordance with the disclosed structure. The speaker device 110 can be removed from the strap for charging or for replacing with a new speaker device. Further, the speaker device 110 is secured to the strap using a locking system that includes a first member 802 pivotally attached to the top edge 804 of the housing 112 and a second member 806 pivotally attached to the bottom edge 808 of the housing 112. The first member 802 and the second member 806 are secured to the rear surface of the strap 102 and are locked with each other at the edges 810, 812 for securing the speaker device 110 to the strap 102.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “communicative pet collar”, “pet collar device”, “pet collar”, “collar device”, and “collar” are interchangeable and refer to the wirelessly coupled pet collar device 100 of the present invention.

Notwithstanding the forgoing, the wirelessly coupled pet collar device 100 of the present invention can be of any suitable size and configuration as is known in the art without affecting the overall concept of the invention, provided that it accomplishes the above stated objectives. One of ordinary skill in the art will appreciate that the wirelessly coupled pet collar device 100 as shown in the FIGS. 1-2 and 8 are for illustrative purposes only, and that many other sizes and shapes of the wirelessly coupled pet collar device 100 are well within the scope of the present disclosure. Although the dimensions of the wirelessly coupled pet collar device 100 are important design parameters for user convenience, the wirelessly coupled pet collar device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A communicative pet strap for interacting between a pet owner and a pet, the
communicative pet strap comprising;
a housing including a Bluetooth enabled speaker and a signal processor, a paired mobile application, and a handheld user device for enabling a pet owner to communicate with said pet strap and a pet;
wherein said housing slidably attached to said pet strap;
wherein said paired mobile application and said handheld user device including a wireless channel for sending digital signals; and
further wherein said signal processor receiving said digital signals via said wireless channel and converting said digital signals into an analog audio signal for playing out by said speaker.

2. The communicative pet strap of claim 1, wherein said audio signal is selected from the group consisting of an instruction, a command, and a message from the pet owner.

3. The communicative pet strap of claim 2, wherein said pet strap is a pet collar.

4. The communicative pet strap of claim 3, wherein said Bluetooth speaker having an audio range from 50 Hz to 5000 Hz.

5. The communicative pet strap of claim 4, wherein said Bluetooth speaker is selected from the group consisting of a micro speaker and a piezoelectric speaker.

6. The communicative pet strap of claim 5, wherein said housing is waterproof.

7. The communicative pet strap of claim 6, wherein said Bluetooth speaker having a Bluetooth module for establishing a wireless channel for communicating with said paired mobile application.

8. The communicative pet strap of claim 7, wherein said wireless channel having a wireless communication link selected from the group consisting of a Wi-Fi, an Infrared, a Bluetooth Low Energy, and a Bluetooth 5.1.

9. A communicative pet strap for interacting between a pet owner and a pet, the communicative pet strap comprising;
a housing including a Bluetooth enabled speaker and a signal processor, a paired mobile application, a vibration module, and a handheld user device for enabling a pet owner to communicate with said pet strap and a pet;
wherein said housing slidably attached to said pet strap;
wherein said paired mobile application and said handheld user device including a wireless channel for sending digital signals;
wherein said signal processor receiving said digital signals via said wireless channel and converting said digital signals into an analog audio signal for playing out by said speaker; and
further wherein a rear surface of said housing including said vibration module for generating a vibration when said audio signal is played out by said speaker.

10. The communicative pet strap of claim 9, wherein said audio signal is selected from the group consisting of an instruction, a command, and a message from the pet owner.

11. The communicative pet strap of claim 10, wherein said pet strap is a pet collar.

12. The communicative pet strap of claim 11, wherein said Bluetooth speaker is selected from the group consisting of a micro speaker and a piezoelectric speaker.

13. The communicative pet strap of claim 12, wherein said housing is waterproof.

14. The communicative pet strap of claim 13, wherein said wireless channel having a wireless communication link selected from the group consisting of a Wi-Fi, an Infrared, a Bluetooth Low Energy, and a Bluetooth 5.1.

15. A method of communicating between a pet owner and a pet, the method comprising the steps of:
providing a communicative pet strap having a housing including a Bluetooth enabled speaker and a signal processor, a paired mobile application, and a handheld user device for enabling a pet owner to communicate with said pet strap and a pet, wherein said paired mobile application and said handheld user device including a wireless channel for sending digital signals;
sending said digital signals from said handheld user device to said pet strap with said paired mobile application, wherein said signal processor receiving said digital signals via said wireless channel, further wherein sending said digital signals is selected from the group consisting of a voice message and a textual message; and
converting said digital signals into an analog audio signal for playing out by said speaker.

16. The method of communicating between a pet owner and a pet of claim 15, wherein said housing having an LED, and further wherein said LED illuminated during the playing out of said analog audio signal by said speaker.

17. The method of communicating between a pet owner and a pet of claim 15, wherein said audio signal is selected from the group consisting of an instruction, a command, and a message from the pet owner.

18. The method of communicating between a pet owner and a pet of claim 15, wherein said pet strap is a wearable pet collar by the pet.

19. The method of communicating between a pet owner and a pet of claim 15, wherein a rear surface of said housing including a vibration module for generating a vibration when said audio signal is played out by said speaker.

20. The method of communicating between a pet owner and a pet of claim 15, wherein said housing having a vital sign detector; wherein said vital sign detector detecting at least one vital sign of the pet; and further wherein said at least one vital sign is selected from the group consisting of a pet heart rate and a pet temperature.
